(19) United States
(12) Patent Application Publication
(10) Pub. No.: US 2011/0320751 A1
(43) Pub. Date: Dec. 29, 2011

(54) Dynamic Interleaving Of Multi-Channel Memory

(75) Inventors: Feng Wang, San Diego, CA (US); Shiqun Gu, San Diego, CA (US); Matthew Michael Nowak, San Diego, CA (US)

(73) Assignee: QUALCOMM Incorporated, San Diego, CA (US)

(21) Appl. No.: 12/823,370

(22) Filed: Jun. 25, 2010

(51) Int. Cl. G06F 12/06

(52) U.S. Cl. 711/157; 711/E12.079

(57) ABSTRACT

In a particular embodiment, a dynamic interleaving system changes the number of interleaving channels of a multi-channel memory based on a detected level of bandwidth requests from a plurality of master ports to a plurality of slave ports. At a low level of bandwidth requests, the number of interleaving channels is reduced.

### I. FIELD

The present disclosure is generally related to a system and method of dynamic interleaving of channels of a multi-channel memory.

### II. DESCRIPTION OF RELATED ART

Advances in technology have resulted in smaller and more powerful personal computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet Protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Most of these devices have processors that need to access more than one block of memory. When processors are accessing more than one block of memory concurrently, memory channel bandwidth can be affected leading to reduced performance.

Interleaving is a technique used to improve memory performance and memory bandwidth efficiency. Interleaving increases bandwidth by allowing simultaneous access to more than one memory channel to achieve load balancing among the available memory channels.

### III. SUMMARY

A dynamic interleaving system is disclosed that dynamically changes the number of interleaving channels of a multi-channel memory based on a detected level of bandwidth requests from a plurality of master ports to a plurality of slave ports. For example, if the level of bandwidth requests is low, then the number of interleaving channels is relatively small. If the level of bandwidth requests is high, then the number of interleaving channels is relatively large. By dynamically reducing the number of interleaving channels when the level of bandwidth requests is relatively low, bandwidth/power efficiency may be conserved. While interleaving can improve performance, interleaving can increase power consumption by reducing chances to power down unused memory channels. Reducing the number of the interleaving channels can reduce power consumption because more memory channels can be powered down and memory channels can stay in a powered down state longer.

In a particular embodiment, a dynamic interleaving system is disclosed that includes a plurality of master ports, a plurality of slave ports, and a bandwidth monitor to detect a level of bandwidth requests from the plurality of master ports to the plurality of slave ports. In a particular embodiment, an interconnection is used to route messages from one or more of the plurality of master ports to one or more of the plurality of slave ports. One or more channels of a multi-channel memory are interleaved based on the level of bandwidth requests. For example, if the bandwidth requests indicate a high level of bandwidth, then the number of interleaving channels is relatively large and if the bandwidth requests indicate a low level of bandwidth, then the number of interleaving channels is relatively low, thereby increasing bandwidth/power efficiency.

In a particular embodiment, each master port of the plurality of master ports and each slave port of the plurality of slave ports includes a bandwidth counter to monitor the level of bandwidth requests. In another particular embodiment, an interleaving controller selectively enables interleaving on one of more channels of a multi-channel memory when the detected level of bandwidth requests exceeds a threshold. The threshold may be programmable by software that communicates with the dynamic interleaving system. In a particular embodiment, the interleaving controller sets an interleaving bit in a register to indicate activation of interleaving of a particular memory channel.

One particular advantage provided by the disclosed embodiments is the ability to dynamically change the number of interleaving channels according to the monitored bandwidth requests. By changing the number of interleaving channels according to the monitored bandwidth requests, only the channels that are needed to support the bandwidth requests are used. As a result, power consumption is reduced and performance is increased.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram that illustrates a particular embodiment of a system to support dynamic interleaving of memory channels;

FIG. 2 is a block diagram that illustrates a reduction of the number of interleaving channels using the system of FIG. 1;

FIG. 3 is a block diagram that illustrates further details of the interconnection of the system of FIG. 1;

FIG. 4 is a flow chart of a particular embodiment of a method of dynamic interleaving;

FIG. 5 is a block diagram of an illustrative communication device that includes a system to support dynamic interleaving; and

FIG. 6 is a flow diagram that illustrates a method of manufacturing an integrated circuit device.

### V. DETAILED DESCRIPTION

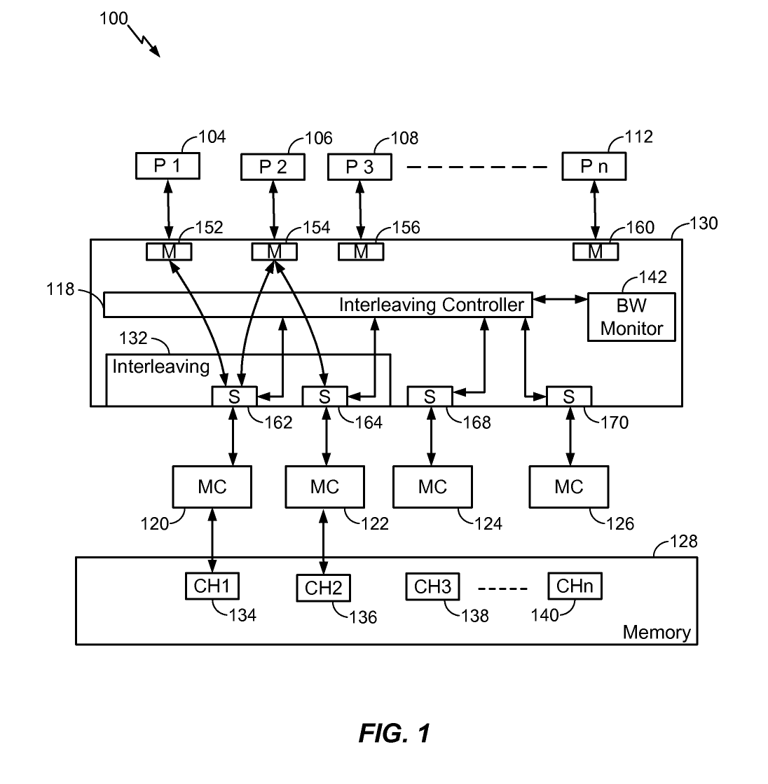

Referring to FIG. 1, a block diagram of a particular embodiment of a dynamic interleaving system that is generally designated 100 is shown. The dynamic interleaving system 100 includes a first processor 104, a second processor 106, a third processor 108, an nth processor 112, an interconnection unit 130, a first memory controller (MC) 120, a second MC 122, a third MC 124, an nth MC 126, and a multi-channel memory 128.

The first processor 104 may be a graphics processor, the second processor 106 may be a text processor, and the third processor 108 may be an audio processor. Each processor is in communication with a master port. For example, the first processor 104 is in communication with a first master port 152, the second processor 106 is in communication with a second master port 154, the third processor 108 is in communication with a third master port 156, and the nth processor 112 is in communication with an nth master port 160.

The first master port 152, the second master port 154, the third master port 156, and the nth master port 160 are representative of a plurality of master ports. The first master port 152, the second master port 154, the third master port 156, and the nth master port 160 are located in an interconnection unit 130. The interconnection unit 130 also includes a first channel slave port 162, a second channel slave port 164, a third channel slave port 168, an nth channel slave port 170, an interleaving controller 118, and a bandwidth monitor 142. The first channel slave port 162, the second channel slave port 164, the third channel slave port 168, and the nth channel slave port 170 are representative of a plurality of slave ports.

The interconnection unit 130 is used to facilitate communication between any of the master ports to any one or more of the slave ports and from any of the slave ports to any one or more of the master ports and contains all structures and logic required to facilitate such communication. The interconnection unit 130 may be an interconnected network of switching devices such as a switch fabric. The bandwidth monitor 142 monitors the level of bandwidth requests from each master port 152, 154, 156, 158, and 160 to each slave port 162, 164, 168 and 170 and is in communication with the interleaving controller 118. Based on the level of bandwidth requests detected by the bandwidth monitor 142, the interleaving controller 118 controls a number of activated interleaving channels. In a particular embodiment, the interleaving controller 118 calculates an estimated power consumption associated with interleaving and uses the estimated power consumption and the monitored bandwidth level to dynamically determine the number of channels to be activated as interleaving channels. In a particular embodiment, the interleaving controller 118 selectively enables interleaving on one or more channels of the multi-channel memory 128 when the detected level of bandwidth requests is above a threshold. In another particular embodiment, the number of interleaving channels is programmable or software controllable. The interleaving controller 118 is in communication with the first channel slave port 162, the second channel slave port 164, the third channel slave port 168, and the nth channel slave port 170. In a particular embodiment, the bandwidth monitor 142, the plurality of master ports, and the plurality of slave ports are intergrated in at least one semiconductor device.

Using the plurality of slave ports, the interconnect unit 130 is in communication with a plurality of MCs, such as the first MC 120, the second MC 122, the third MC 124, and the nth MC 126, as shown in FIG. 1. The first MC 120 is configured to access a first channel of memory 134, the second MC 122 is configured to access a second channel of memory 136, the third MC 124 is configured to access a third channel of memory 138, and the nth MC 126 is configured to access an nth channel memory 140. The first channel of memory 134, the second channel of memory 136, the third channel of memory 138, and the nth channel memory 140 are coupled to the multi-channel memory 128. In a particular embodiment, the multi-channel memory 128 operates with double-data-rate transfer on both the rising and falling edges of a clock signal, such as a double-data-rate synchronous dynamic random access memory (DDR-SDRAM).

During operation of the dynamic interleaving system 100, one or more of the processors issues a bandwidth request to obtain data from the multi-channel memory 128. The bandwidth request is transmitted to the master port associated with the processor that issues the bandwidth request. The master port determines what channel of memory contains the requested data and forwards the bandwidth request to the slave port associated with the channel of memory that contains the requested data. For example, as shown in FIG. 1, the bandwidth request from the first processor 104 is processed by master port 152, and the bandwidth request from the second processor 106 is processed by master port 154. Each bandwidth request is communicated through the interleaving controller 118 to one or more slave ports that are associated with the memory channel that contains the requested data from the memory 128. For example, as shown in FIG. 1, the first master port 152 communicates a bandwidth request to the first channel slave port 162 to obtain requested data from the first channel of memory 134, and the second master port 154 communicates a bandwidth request to the first channel slave port 162 to obtain requested data from the first channel of memory 134 and to the second channel slave port 164 to obtain the requested data from the second channel of memory 136.

The bandwidth requests pass through the interleaving controller 118, and the bandwidth monitor 142 monitors and detects the level of bandwidth requests from each of the plurality of master ports 152, 154, 156, 158, and 160. Based on the level of bandwidth requests, one or more channels of the multi-channel memory 128 may be selectively designated as interleaving channels, such that when the bandwidth requests indicate a high level of requested bandwidth, then the number of interleaving channels is relatively large. When the bandwidth requests indicate a low level of requested bandwidth, then the number of interleaving channels is relatively low, thereby reducing power consumption due to interleaving. For example, as shown in FIG. 1, when the bandwidth requests indicate a relatively low level of bandwidth, data from the first channel of memory 134 and the data from the second channel of memory 136 are interleaved, but no interleaving is performed on the channels to the MCs 124, 126, resulting in reduced power consumption.

The slave port associated with the channel of memory that contains the requested data communicates with the associated memory controller to access the memory channel containing the requested data. For example, as shown in FIG. 1, the bandwidth request received by the first channel slave port 162 is communicated to the first MC 120, and the bandwidth request received by the second channel slave port 164 is communicated to the second MC 122. The first MC 120 accesses the first channel of memory 134 to obtain the data requested by the first processor 104 and the second processor 106. The second MC 122 accesses the second memory channel 136 to obtain the data requested by the second processor 106. The first MC 120 and the second MC 122 communicate the accessed data to the first slave port 162 and to the second slave port 164, respectively. The data is interleaved, as shown at 132, and communicated to the first master controller 152, the first processor 104, the second master controller 154, and the second processor 106.

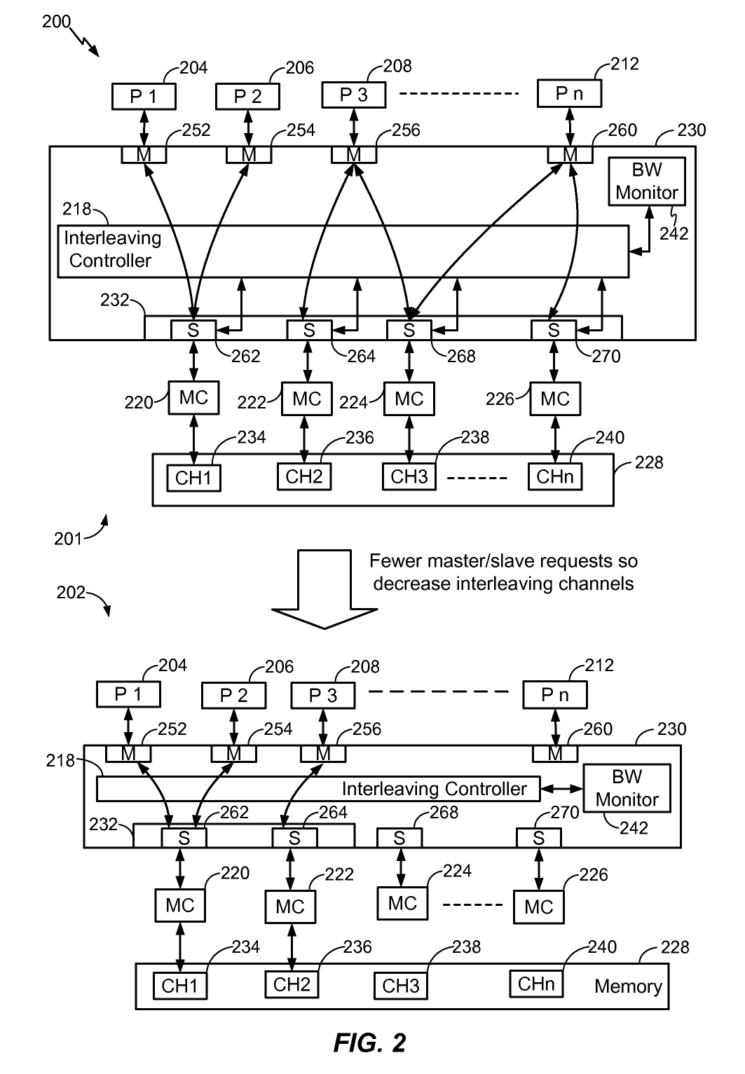

FIG. 2 illustrates a method of reducing the number of interleaving channels using a dynamic interleaving system 200. The dynamic interleaving system 200 is similar to the dynamic interleaving system 100 shown in FIG. 1. A particular embodiment of the dynamic interleaving system 200 includes a first processor 204, a second processor 206, a third processor 208, and an nth processor 212. Each processor may be a part of a system processor or may be a stand alone processor. The first processor 204 is in communication with a first master port 252, the second processor 206 is in communication with a second master port 254, the third processor 208 is in communication with a third master port 256, and the nth processor 212 is in communication with an nth master port 260. The first master port 252, the second master port 254, the third master port 256, and the nth master port 260 are representative of a plurality of master ports. The number and type of processors and masters may vary depending on the particular system design and implementation.

The first master port 252, the second master port 254, the third master port 256, and the nth master port 260 may be contained in an interconnection unit 230. The interconnection unit 230 also includes a first channel slave port 262, a second channel slave port 264, a third channel slave port 268, an nth channel slave port 270, an interleaving controller 218, and a bandwidth monitor 242. The first channel slave port 262, the second channel slave port 264, the third channel slave port 268, and the nth channel slave port 270 are representative of a plurality of slave ports.

The bandwidth monitor 242 monitors the level of bandwidth requests from each master port 252, 254, 256, 258, and 260 to each slave port 262, 264, 268 and 270 and is in communication with the interleaving controller 218. The interleaving controller 218 controls the number of interleaving channels based on the monitored level of bandwidth requests as detected by the bandwidth monitor 242. In a particular embodiment, the interleaving controller 218 calculates an estimated power consumption associated with interleaving, and the estimated power consumption and the monitored bandwidth level is used to dynamically determine the number of interleaving channels. In another particular embodiment, the interleaving controller 218 controls the number of interleaving channels based on an address map. The interleaving controller 218 is in communication with the first channel slave port 262, the second channel slave port 264, the third channel slave port 268, and the nth channel slave port 270 and is adapted to selectively enable interleaving on one or more channels to the multi-channel memory coupled to the plurality of slave ports 262, 264, 268 and 270.

Using the plurality of slave ports, the interconnect unit 230 is in communication with a first MC 220, a second MC 222, a third MC 224, and an nth MC 226. The first MC 220 is able to access a first channel of memory 234, the second MC 222 is able to access a second channel of memory 236, the third MC 224 is able to access a third channel of memory 238, and the nth MC 226 is able to access an nth channel of memory 240 of the multi-channel memory device 228. In a particular embodiment, the multi-channel memory device 228 operates with double-data-rate transfers on both the rising and falling edges of a clock signal, such as double-data-rate synchronous dynamic random access memory (DDR-SDRAM).

During operation of the dynamic interleaving system 200, one or more of the processors issues a bandwidth request to access data from the multi-channel memory device 228. The bandwidth request is transmitted to the master port associated with the processor that requests the data. Each master port determines the channel of memory associated with the requested data and forwards the bandwidth request to the slave port associated with the channel of memory. The bandwidth request is communicated through the interleaving controller 218 to one or more slave ports that are associated with the memory channel.

The bandwidth requests travel through the interleaving controller 218, and the bandwidth monitor 242 monitors the level of bandwidth requests from each master port. The level of bandwidth requests determined by the bandwidth monitor 242 is communicated to the interleaving controller 218. Based on the level of bandwidth requests, the interleaving controller 218 interleaves one or more channels of a multi-channel memory. For example, when the bandwidth requests indicate a relatively high level of bandwidth requests, then the number of interleaving channels is relatively large and if the bandwidth requests indicate a relatively low level of bandwidth requests, then the number of interleaving channels is relatively low.

The slave port associated with the channel of memory communicates with the memory controller to access the memory channel. Data obtained by the memory controller is communicated to the corresponding slave port where the data is interleaved and communicated to a master controller and then forwarded to the processor that requested the data.

For example, in a high bandwidth operations phase 201, all the processors have issued bandwidth requests to obtain data from the multi channel memory 228 and all channels are interleaved, as shown at 232. Because the bandwidth monitor 242 detects a high level of bandwidth requests, the number of interleaving channels is large. In a low bandwidth operations phase 202, when the level of bandwidth requests indicate a relatively low level, the number of interleaving channels is reduced to a lower number (e.g. only two interleaving channels shown at 232 in low bandwidth operations phase 202). In the high bandwidth operations phase 201 all the channels are interleaved and bandwidth/power efficiency is low. In contrast, during the low bandwidth operations phase 202, only two channels are interleaved and bandwidth/power efficiency is high. Hence, by dynamically reducing the number of interleaving channels when the level of bandwidth requests is relatively low, bandwidth/power efficiency may be conserved.

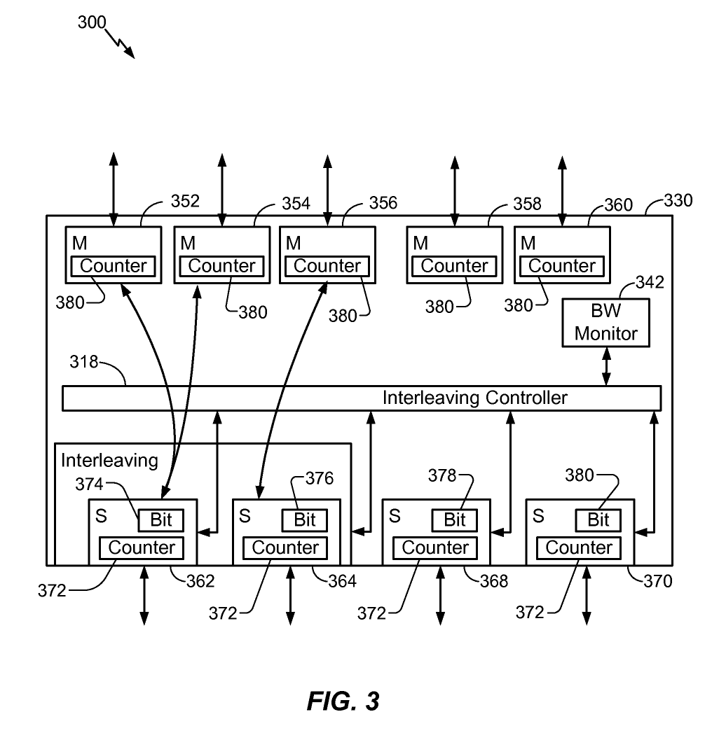

Referring to FIG. 3, a block diagram of a particular embodiment of an interconnection unit that is generally designated 300 is shown. The interconnection unit 300 may be similar to or the same as the interconnection units 130 and 230 shown in FIGS. 1 and 2. The interconnection unit 300 includes a first master port 352, a second master port 354, a third master port 356, an nth master port 360, a first channel slave port 362, a second channel slave port 364, a third channel slave port 368, an nth channel slave port 370, and an interleaving controller 318. In a particular embodiment, the interconnection unit 300 also includes a bandwidth monitor 342. The first master port 352, the second master port 354, the third master port 356, and the nth master port 360 are representative of a plurality of master ports. The first channel slave port 362, the second channel slave port 364, the third channel slave port 368, and the nth channel slave port 370 are representative of a plurality of slave ports. The interleaving controller 318 controls the number of interleaving channels and is in communication with the first channel slave port 362, the second channel slave port 364, the third channel slave port 368, and the nth channel slave port 370.

In a particular embodiment, the bandwidth monitor 342 monitors the level of bandwidth requests sent from each master port 352, 354, 356, 358, and 360 to each slave port 362, 364, 368 and 370 and communicates the monitored bandwidth level to the interleaving controller 318. In another particular embodiment, the first master port 352, the second master port 354, the third master port 356, and the nth master port 360 each include a master bandwidth counter 380. The master bandwidth counter 380 counts each bandwidth request sent by the first master port 352, the second master port 354, the third master port 356, and the nth master port 360 and communicates a count of the number of bandwidth requests from each master port to the interleaving controller 318.

In a particular embodiment, the first channel slave port 362, the second channel slave port 364, the third channel slave port 368, and the nth channel slave port 370 each include a slave bandwidth counter 372. The slave bandwidth counters 372 count each bandwidth request received by the first channel slave port 362, the second channel slave port 364, the third channel slave port 368, and the nth channel slave port 370 and communicates the counted number of bandwidth requests from each slave port to the interleaving controller 318. In another particular embodiment, the first master port 352, the second master port 354, the third master port 356, and the nth master port 360 each contain the master bandwidth counter 370 and the first channel slave port 362, the second channel slave port 364, the third channel slave port 368, and the nth channel slave port 370 each contain the slave bandwidth counter 372.

In a particular embodiment, the bandwidth monitor 342 is replaced by the master bandwidth counters 370, the slave bandwidth counters 372, or both the master bandwidth counters 370 and the slave bandwidth counters 372. Based on the level of bandwidth requests determined by the bandwidth monitor 342, the master bandwidth counters 370, the slave bandwidth counters 372, or any combination thereof, the interleaving controller 318 selectively interleaves one or more channels of a multi-channel memory.

In one particular embodiment, the first channel slave port 362 includes an interleaving bit 374, the second channel slave port 364 includes an interleaving bit 376, the third channel slave port 368 includes an interleaving bit 378, and the nth channel slave port 370 includes an interleaving bit 380 in a register to indicate activation of interleaving of a particular memory channel. The interleaving bits 374, 376, 378, and 380 are each set by the interleaving controller 318 when the respective channel is to be included in the interleaving operation.

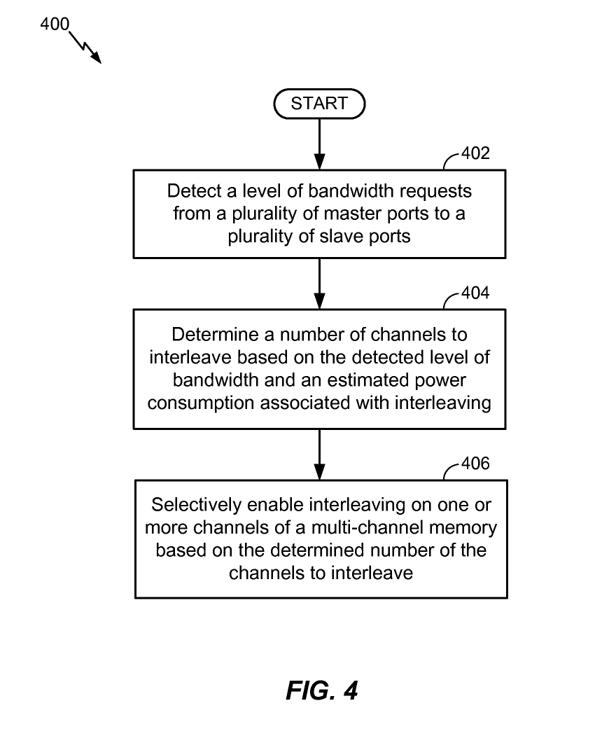

Referring to FIG. 4, a particular illustrative embodiment of a method of dynamically interleaving channels of a multi-channel memory is depicted and generally designated 400. In an illustrative embodiment, the method 400 may be performed by the system 100 of FIG. 1, the system 200 of FIG. 2, or the system 300 of FIG. 3.

In a particular embodiment, a level of bandwidth requests from a plurality of master ports to a plurality of slave ports is detected, at 402. For example, the bandwidth monitor 142 monitors and detects the level of bandwidth requests from the first master port 152, the second master port 154, the third master port 156, and the nth master port 160 to the first channel slave port 162, the second channel slave port 164, the third channel slave port 168, and the nth channel slave port 170, as in FIG. 1. Continuing to 404, a number of channels to interleave is determined based on the detected level of bandwidth requests and an estimated power consumption associated with interleaving. For example, based on the level of bandwidth requests detected by the bandwidth monitor 142 and the estimated power consumption associated with interleaving determined by the interleaving controller 118, the interleaving controller 118 dynamically determines the number of channels to interleave, as in FIG. 1. In a particular embodiment, a number of channels to interleave based on the detected level of bandwidth requests is determined. For example, based at least in part on the detected level of bandwidth requests by the bandwidth monitor 142, the interleaving controller 118 determines the number of channels to interleave, in FIG. 1. Moving to 406, interleaving is selectively enabled on one or more channels of a multi-channel memory based on the determined number of the channels to interleave. For example, as shown in FIG. 1, the first channel of memory 134 and the second channel of memory 136 have been interleaved at the first slave port 152 and the second slave port 164, as indicated at 132 in FIG. 1. Also, referring to FIG. 2, in the high bandwidth operations phase 201 all the channels are interleaved and then, when level of bandwidth requests is reduced, in the low bandwidth operations phase 202, two channels are interleaved.

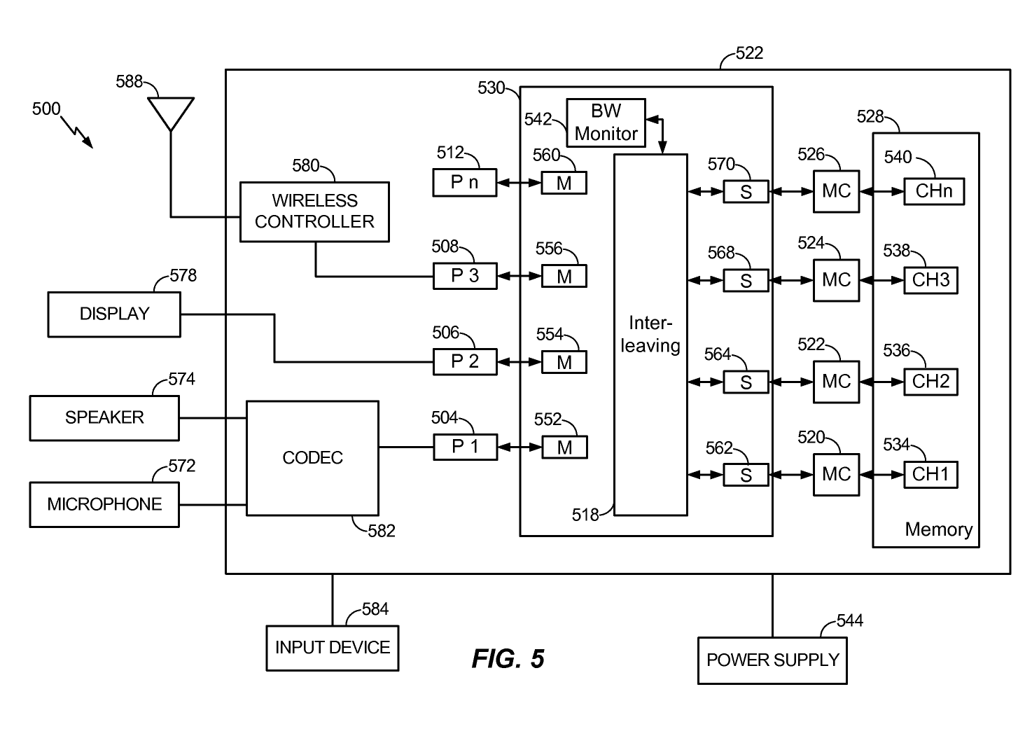

FIG. 5 is a block diagram of an illustrative embodiment of a wireless communication device generally designated 500. The wireless communication device 500 may be a cellular phone, a terminal, a handset, a personal digital assistant (“PDA”), a wireless modem, or other wireless device. The wireless communication device 500 may be used with a wireless communication system such as a Code Division Multiple Access (CDMA) system, a Global System for Mobile Communications (GSM) system, or similar communication system.

The wireless communications device 500 includes a microphone 572, a speaker 574, a display 578, a wireless controller 580, an antenna 588, an input device 584, a power supply 544, a first processor 504, a second processor 506, a third processor 508, an nth processor 512, an interconnection unit 530, a first MC 520, a second MC 522, a third MC 524, an nth MC 526, and a multi-channel memory 528. In a particular embodiment, the first processor 504 is an audio processor and communicates with the microphone 572 and the speaker 574 through a coder/decoder (CODEC) 582, the second processor 506 is a video processor and communicates with the display 578, the third processor 508 is a digital signal processor and communicates with the wireless controller 580. In a particular embodiment, a power supply 544 and an input device 584 are coupled to an on-chip system 522. In a particular embodiment, as illustrated in FIG. 5, the display 578, the input device 584, the speaker 574, the microphone 572, the wireless antenna 588, and the power supply 544 are external to the on-chip system 522.

The interconnection unit 530 includes a first master port 552, a second master port 554, a third master port 556, an nth master port 560, a first channel slave port 562, a second channel slave port 564, a third channel slave port 568, an nth channel slave port 570, and an interleaving controller 518. The interleaving controller 518 controls the number of interleaving channels and is in communication with the first channel slave port 562, the second channel slave port 564, the third channel slave port 568, and the nth channel slave port 570. In a particular embodiment, the interconnection unit 530 also includes a bandwidth monitor 542. The bandwidth monitor 542 monitors the level of bandwidth requests sent from each master port 552, 554, 556, 558, and 560 to each slave port 562, 564, 568 and 570 and communicates the monitored bandwidth level to the interleaving controller 518.

Using each slave port 562, 564, 568 and 570, the interconnect unit 530 is in communication with a first channel MC 520, a second MC 522, a third MC 524, and an nth MC 526. The first MC 520 is able to access a first channel of memory 534, the second MC 522 is able to access a second channel of memory 536, the third MC 524 is able to access a third channel of memory 538, and the nth MC 526 is able to access an nth channel memory 540. Each memory channel is contained in the multi-channel memory device 528.

During operation of the wireless communications device 500, one or more of the processors issues a bandwidth request to obtain data from the multi-channel memory device 528. The bandwidth request is transmitted to the master port associated with the processor that requests the data. Each master port determines the channel of memory corresponding to the requested data and forwards the bandwidth request to the slave port associated with the channel of memory corresponding to the requested data. The bandwidth request is communicated through the interleaving controller 518 to one or more slave ports that are associated with the memory channel.

The bandwidth requests travel through the interleaving controller 518, and the bandwidth monitor 542 monitors the level of bandwidth requests from each master port. The level of bandwidth requests determined by the bandwidth monitor 542 is communicated to the interleaving controller 518. Based on the level of bandwidth requests, the interleaving controller 518 interleaves one or more channels of a multi-channel memory. For example, when the bandwidth monitor 542 indicates a relatively high level of bandwidth requests, the number of interleaving channels is relatively large and if the bandwidth monitor 542 indicates a relatively low level of bandwidth requests, then the number of interleaving channels is relatively low.

The slave port associated with the channel of memory corresponding to the requested data communicates with the memory controller to access the memory channel. Data obtained by the memory controller is communicated to the corresponding slave port where the data is interleaved and communicated to a master controller and then forwarded to the processor that requested the data.

The foregoing disclosed devices and functionalities may be designed and configured into computer files (e.g. RTL, GDSII, GERBER, etc.) stored on computer readable media. Some or all such files may be provided to fabrication handlers who fabricate devices based on such files. Resulting products include semiconductor wafers that are then cut into semiconductor die and packaged into a semiconductor chip. The chips are employed in electronic devices.

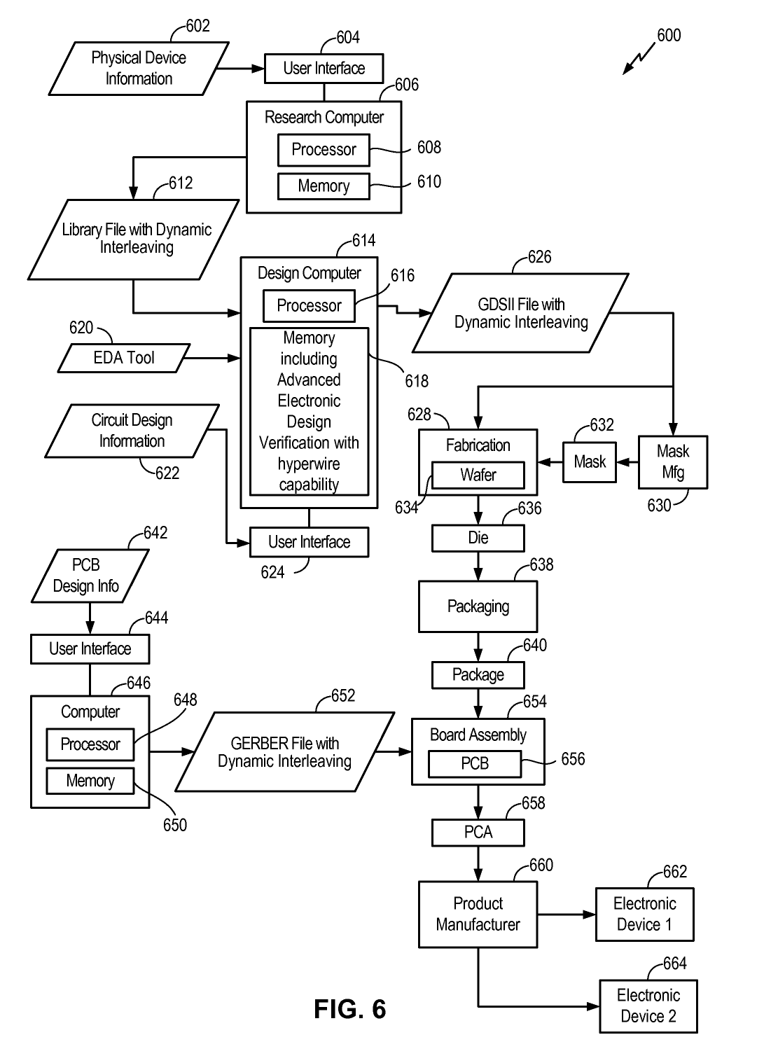

FIG. 6 depicts a particular illustrative embodiment of an electronic device manufacturing process 600. Physical device information 602 is received in the manufacturing process 600, such as at a research computer 606. The physical device information 602 may include design information representing at least one physical property of a dynamic interleaving system used in a semiconductor device, such as elements of the dynamic interleaving system of FIG. 1, FIG. 2, or FIG. 3. For example, the physical device information 602 may include physical parameters, material characteristics, and structure information that is entered via a user interface 604 coupled to the research computer 606. The research computer 606 includes a processor 608, such as one or more processing cores, coupled to a computer readable medium such as a memory 610. The memory 610 may store computer readable instructions that are executable to cause the processor 608 to transform the physical device information 602 to comply with a file format and to generate a library file 612.

In a particular embodiment, the library file 612 includes at least one data file including the transformed design information. For example, the library file 612 may include a library of semiconductor devices including one or more components of the dynamic interleaving system of FIG. 1, FIG. 2, or FIG. 3 that is provided for use with an electronic design automation (EDA) tool 620.

The library file 612 may be used in conjunction with the EDA tool 620 at a design computer 614 including a processor 616, such as one or more processing cores, coupled to a memory 618. The EDA tool 620 may be stored as processor executable instructions at the memory 618 to enable a user of the design computer 614 to design a circuit using one or more components of the dynamic interleaving system of FIG. 1, FIG. 2, or FIG. 3, of the library file 612. For example, a user of the design computer 614 may enter circuit design information 622 via a user interface 624 coupled to the design computer 614. The circuit design information 622 may include design information representing at least one physical property of a semiconductor device, such as one or more components of the dynamic interleaving system of FIG. 1, FIG. 2, or FIG. 3. To illustrate, the circuit design property may include identification of particular circuits and relationships to other elements in a circuit design, positioning information, feature size information, interconnection information, or other information representing a physical property of a semiconductor device.

The design computer 614 may be configured to transform the design information including the circuit design information 622 to comply with a file format. To illustrate, the file format may include a database binary file format representing planar geometric shapes, text labels, and other information about a circuit layout in a hierarchical format, such as a Graphic Data System (GDSII) file format. The design computer 614 may be configured to generate a data file including the transformed design information, such as a GDSII file 626 that includes information describing one or more components of the dynamic interleaving system of FIG. 1, FIG. 2, or FIG. 3 in addition to other circuits or information. To illustrate, the GDSII file 626 may include information corresponding to a system-on-chip (SOC) that includes one or more components of the dynamic interleaving system of FIG. 1, FIG. 2, or FIG. 3 and that also includes additional electronic circuits and components within the SOC.

The GDSII file 626 may be received at a fabrication process 628 to manufacture one or more components of the dynamic interleaving system of FIG. 1, FIG. 2, or FIG. 3 according to transformed information in the GDSII file 626. For example, a device manufacture process may include providing the GDSII file 626 to a mask manufacturer 630 to create one or more masks, such as masks to be used for photolithography processing, illustrated as a representative mask 632. The mask 632 may be used during the fabrication process to generate one or more wafers 634, which may be tested and separated into dies, such as a representative die 636. The die 636 includes a circuit including one or more components of the dynamic interleaving system of FIG. 1, FIG. 2, or FIG. 3.

The die 636 may be provided to a packaging process 638 where the die 636 is incorporated into a representative package 640. For example, the package 640 may include the single die 636 or multiple dies, such as a system-in-package (SiP) arrangement. The package 640 may be configured to conform to one or more standards or specifications, such as Joint Electron Device Engineering Council (JEDEC) standards.

Information regarding the package 640 may be distributed to various product designers, such as via a component library stored at a computer 646. The computer 646 may include a processor 648, such as one or more processing cores, coupled to a memory 650. A printed circuit board (PCB) tool may be stored as processor executable instructions at the memory 650 to process PCB design information 642 received from a user of the computer 646 via a user interface 644. The PCB design information 642 may include physical positioning information of a packaged semiconductor device on a circuit board, the packaged semiconductor device corresponding to the package 640 including one or more components of the dynamic interleaving system of FIG. 1, FIG. 2, or FIG. 3.

The computer 646 may be configured to transform the PCB design information 642 to generate a data file, such as a GERBER file 652 with data that includes physical positioning information of a packaged semiconductor device on a circuit board, as well as layout of electrical connections such as traces and vias, where the packaged semiconductor device corresponds to the package 640 including one or more components of the dynamic interleaving system of FIG. 1, FIG. 2, or FIG. 3. In other embodiments, the data file generated by the transformed PCB design information may have a format other than a GERBER format.

The GERBER file 652 may be received at a board assembly process 654 and used to create PCBs, such as a representative PCB 656, manufactured in accordance with the design information stored within the GERBER file 652. For example, the GERBER file 652 may be uploaded to one or more machines for performing various steps of a PCB production process. The PCB 656 may be populated with electronic components including the package 640 to form a representative printed circuit assembly (PCA) 658.

The PCA 658 may be received at a product manufacture process 660 and integrated into one or more electronic devices, such as a first representative electronic device 662 and a second representative electronic device 664. As an illustrative, non-limiting example, the first representative electronic device 662, the second representative electronic device 664, or both, may be selected from the group of a set top box, a music player, a video player, an entertainment unit, a navigation device, a communications device, and a computer. As another illustrative, non-limiting example, one or more of the electronic devices 662 and 664 may be remote units such as mobile phones, hand-held personal communication systems (PCS) units, portable data units such as personal data assistants, global positioning system (GPS) enabled devices, navigation devices, fixed location data units such as meter reading equipment, or any other device that stores or retrieves data or computer instructions, or any combination thereof.

Thus, one or more components of the dynamic interleaving system of FIG. 1, FIG. 2, or FIG. 3 may be fabricated, processed, and incorporated into an electronic device, as described in the illustrative process 600. One or more aspects of the embodiments disclosed with respect to FIGS. 1-5 may be included at various processing stages, such as within the library file 612, the GDSII file 626, and the GERBER file 652, as well as stored at the memory 610 of the research computer 606, the memory 618 of the design computer 614, the memory 650 of the computer 646, the memory of one or more other computers or processors (not shown) used at the various stages, such as at the board assembly process 654, and also incorporated into one or more other physical embodiments, such as the mask 632, the die 636, the package 640, the PCA 658, other products such as prototype circuits or devices (not shown), or any combination thereof. Although various representative stages of production from a physical device design to a final product are depicted. In other embodiments fewer stages may be used or additional stages may be included. Similarly, the process 600 may be performed by a single entity or by one or more entities performing various stages of the process 600.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), a magnetoresistive random access memory (MRAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. An apparatus comprising:
a plurality of master ports;
a plurality of slave ports;
a bandwidth monitor to detect a level of bandwidth requests from the plurality of master ports to the plurality of slave ports; and
one or more interleaving channels of a multi-channel memory wherein the number of interleaving channels is based on the detected level of bandwidth requests.

2. The apparatus of claim 1, wherein each master port of the plurality of master ports and each slave port of the plurality of slave ports comprises a bandwidth counter.

3. The apparatus of claim 1, further comprising an interleaving controller to selectively enable interleaving on one of more channels of the multi-channel memory when the detected level of bandwidth requests is above a threshold.

4. The apparatus of claim 3, wherein the threshold is programmable.

5. The apparatus of claim 3, wherein the interleaving controller sets an interleaving bit in a register to indicate activation of interleaving of a particular memory channel.

6. The apparatus of claim 1, further comprising an interconnection unit to route messages from one or more of the plurality of master ports to one or more of the plurality of slave ports.

7. The apparatus of claim 1, wherein the bandwidth monitor, the plurality of master ports, and the plurality of slave ports are integrated in at least one semiconductor device.

8. The apparatus of claim 7, further comprising a device, selected from the group consisting of a set top box, a music player, a video player, an entertainment unit, a navigation device, a communications device, a personal digital assistant (PDA), a fixed location data unit, and a computer, into which the semiconductor device is integrated.

9. An apparatus comprising:
means for detecting a level of bandwidth requests from a plurality of master ports to a plurality of slave ports; and
means for interleaving channels of a multi-channel memory wherein the number of interleaving channels is based on the detected level of bandwidth requests.

10. The apparatus of claim 9, integrated in at least one semiconductor device.

11. The apparatus of claim 10, further comprising a device, selected from the group consisting of a set top box, a music player, a video player, an entertainment unit, a navigation device, a communications device, a personal digital assistant (PDA), a fixed location data unit, and a computer, into which the semiconductor device is integrated.

12. A method comprising:
detecting a level of bandwidth requests from a plurality of master ports to a plurality of slave ports;
determining a number of channels to interleave based on the detected level of bandwidth requests; and
selectively enabling interleaving on one or more channels of a multi-channel memory based on the determined number of the channels to interleave.

13. The method of claim 12, wherein the bandwidth requests are communicated from the plurality of master ports to the plurality of slave ports within an interconnection unit.

14. The method of claim 12, wherein the number of channels is further based on an estimated power consumption associated with interleaving.

15. The method of claim 12, wherein the interleaving of selected channels of the multi-channel memory is software controllable.

16. The method of claim 12, further comprising a counter to detect a number of bandwidth requests.

17. The method of claim 12 wherein each master port of the plurality of master ports and each slave port of the plurality of slave ports comprises a bandwidth counter.

18. The method of claim 12, wherein the interleaving is based on an address map.

19. A method comprising:
a first step to detect a level of bandwidth requests from a plurality of master ports to a plurality of slave ports;
a second step to determine a number of channels to interleave based on the detected level of bandwidth requests; and
a third step to selectively enable interleaving on one or more channels of a multi-channel memory based on the determined number of the channels.

20. The method of claim 19, wherein the first step, the second step, and the third step are performed by a processor integrated into an electronic device.

21. A computer readable tangible medium storing instructions executable by a computer, comprising:
instructions executable by the computer to detect a level of bandwidth requests from a plurality of master ports to a plurality of slave ports;
instructions executable by the computer to determine a number of channels to interleave based on the level of bandwidth requests; and
instructions executable by the computer to selectively enable interleaving on one or more channels of a multi-channel memory based on the determined number of the channels.

22. The computer readable tangible medium of claim 21, wherein the instructions are executable by a processor integrated in a device selected from the group consisting of a set top box, a music player, a video player, an entertainment unit, a navigation device, a communications device, a personal digital assistant (PDA), a fixed location data unit, and a computer.

23. A method comprising:
receiving design information representing at least one physical property of a semiconductor device, the semiconductor device comprising:
a plurality of master ports;
a plurality of slave ports;
a bandwidth monitor to detect a level of bandwidth requests from the plurality of master ports to the plurality of slave ports; and
an interleaving controller to interleave one or more channels of a multi-channel memory wherein the number of interleaved channels is based on the detected level of bandwidth requests;
transforming the design information to comply with a file format; and
generating a data file including the transformed design information.

24. The method of claim 23, wherein the data file comprises a GDSII format file.

25. A method comprising:
receiving a data file comprises design information corresponding to a semiconductor device; and
fabricating the semiconductor device according to the design information, wherein the semiconductor device comprises:
a plurality of master ports;
a plurality of slave ports;
a bandwidth monitor to detect a level of bandwidth requests from the plurality of master ports to the plurality of slave ports; and
an interleaving controller to interleave one or more channels of a multi-channel memory wherein the number of interleaved channels is based on the detected level of bandwidth requests.

26. The method of claim 25, wherein the data file comprises a GDSII format file.

27. A method comprising:
receiving design information comprising physical positioning information of a packaged semiconductor device on a circuit board, the packaged semiconductor device including a semiconductor device comprising:
a plurality of master ports;
a plurality of slave ports;
a bandwidth monitor to detect a level of bandwidth requests from the plurality of master ports to the plurality of slave ports; and
an interleaving controller to interleave one or more channels of a multi-channel memory wherein the number of interleaved channels is based on the detected level of bandwidth requests; and
transforming the design information to generate a data file.

28. The method of claim 27, wherein the data file has a GERBER format.

29. A method comprising:
receiving a data file comprising design information including physical positioning information of a packaged semiconductor device on a circuit board; and
manufacturing the circuit board configured to receive the packaged semiconductor device according to the design information, wherein the packaged semiconductor device includes a semiconductor device comprising:
a plurality of master ports;
a plurality of slave ports;
a bandwidth monitor to detect a level of bandwidth requests from the plurality of master ports to the plurality of slave ports; and
an interleaving controller to interleave one or more channels of a multi-channel memory wherein the number of interleaved channels is based on the detected level of bandwidth requests.

30. The method of claim 29, wherein the data file has a GERBER format.

31. The method of claim 29, further comprising integrating the circuit board into a device selected from the group consisting of a set top box, a music player, a video player, an entertainment unit, a navigation device, a communications device, a personal digital assistant (PDA), a fixed location data unit, and a computer.
